(19) United States
(12) Patent Application Publication
(10) Pub. No.: US 2005/0104958 A1
(43) Pub. Date: May 19, 2005

(54) Active camera video-based surveillance systems and methods

(76) Inventors: Geoffrey Egnal, Washington, DC (US); Andrew Chosak, Arlington, VA (US); Niels Haering, Reston, VA (US); Alan J. Lipton, Herndon, VA (US); Peter L. Venetianer, McLean, VA (US); Weihong Yin, Herndon, VA (US); Zhong Zhang, Herndon, VA (US)

Correspondence Address: VENABLE, BAETJER, HOWARD AND CIVILETTI, LLP, P.O. BOX 34385, WASHINGTON, DC, 20043-9998, US

(21) Appl. No.: 10/705,896

(22) Filed: Nov. 13, 2003

(51) Int. Cl. H04N 7/18

(52) U.S. Cl. 348/143; 348/169

(57) ABSTRACT

A video surveillance system comprises a sensing unit capable of being operated in a first mode and second mode and a computer system coupled to the sensing unit. The computer system is adapted to receive and process image data from the sensing unit, to detect and track targets, and to determine whether the sensing unit operates in the first mode or in the second mode based on the detection and tracking of targets.

### FIELD OF THE INVENTION

The present invention is related to methods and systems for performing video-based surveillance. More specifically, the invention is related to such systems involving multiple interacting sensing devices (e.g., video cameras).

### BACKGROUND OF THE INVENTION

Many businesses and other facilities, such as banks, stores, airports, etc., make use of security systems. Among such systems are video-based systems, in which a sensing device, like a video camera, obtains and records images within its sensory field. For example, a video camera will provide a video record of whatever is within the field-of-view of its lens. Such video images may be monitored by a human operator and/or reviewed later by a human operator. Recent progress has allowed such video images to be monitored also by an automated system, thus saving the human labor.

In many situations, for example, if a robbery is in progress, it would be desirable to detect a target (e.g., a robber) and obtain a high quality video or picture of the target. However, a typical purchaser of a security system may be driven by cost considerations to install as few sensing devices as possible. In typical systems, therefore, one or a few wide-angle cameras are used, in order to obtain the broadest coverage at the lowest cost. A system may further include a pan-tilt-zoom (PTZ) sensing device, as well, in order to obtain a high-resolution image of a target. The problem, however, is that such systems require a human operator to recognize the target and to train the PTZ sensing device on the recognized target, a process which is inaccurate and often too slow to catch the target. Other methods to obtain high-resolution images also exist, such as using a polarized filter when filming a reflection on water, using a super-resolution algorithm to get more resolution on the target, or using a digital enhancement of another kind to attain better imagery. The problem with these methods is that they either require computational power that would prohibit normal operation or require a different sensing modality that would disturb normal operation. In either case, automating the process of acquiring higher quality images, by switching to capture these high-quality images only when necessary, would increase the reliability and accuracy of the surveillance system.

### SUMMARY OF THE INVENTION

The present invention is directed to a system and method for automating the above-described process. That is, the present invention requires relatively few cameras (or other sensing devices), and it uses a single camera in a wide-angle mode to spot unusual activity, and then switches the camera to a PTZ mode, to zoom in and record recognition information. This is done without any human intervention.

According to one embodiment, the invention may comprise a video surveillance system comprising a sensing unit capable of being operated in a first mode and second mode; and a computer system coupled to the sensing unit, the computer system receiving and processing image data from the sensing unit, detecting and tracking targets, and determining whether the sensing unit operates in the first mode or in the second mode based on the detection and tracking of targets.

According to another embodiment, the invention may comprise a method of operating a video surveillance system, the video surveillance system including at least one sensing unit capable of being operated in first and second modes. The method of this embodiment may comprise: operating a sensing unit in the first mode to scan for targets; processing image data from the sensing unit in a first mode to detect the presence of an interesting target; upon detecting an interesting target, operating the sensing unit in the second mode to track the interesting target and to improve the quality of information about the interesting target over the information that can be obtained in the first mode; and processing image data from the sensing unit in a second mode to track the target by sending at least one of pan, tilt, and zoom commands to the sensing unit. The method of this embodiment may be implemented as software on a computer-readable medium. Furthermore, the invention may be embodied in the form of a computer system running such software.

Another embodiment of the invention may comprise a motion detection module to determine camera motion. The motion detection module may comprise a corner detection module to find interesting points; a search module to find matches for interesting points between successive images; a confidence value assignment module to assign confidence values to the matches of the interesting points; a robust averaging module to determine an estimate from a set of high confidence matches; a warping module to warp one successive image to another successive image for direct comparison of the images; and a subtraction module, which subtracts the warped image from a current image to determine which pixels have moved.

Further embodiments of the invention may include security systems and methods, as discussed above and in the subsequent discussion.

Further embodiments of the invention may include systems and methods of monitoring scientific experiments. For example, inventive systems and methods may be used to focus in on certain behaviors of subjects of experiments.

Further embodiments of the invention may include systems and methods useful in monitoring and recording sporting events. For example, such systems and methods may be useful in detecting certain behaviors (e.g., penalty-related actions in football or soccer games).

Yet further embodiments of the invention may be useful in gathering marketing information. For example, using the invention, one may be able to monitor the behaviors of customers (e.g., detecting interest in products by detecting what products they reach for).

### DEFINITIONS

The following definitions are applicable throughout this disclosure, including in the above.

A “video” refers to motion pictures represented in analog and/or digital form. Examples of video include: television, movies, image sequences from a video camera or other observer, and computer-generated image sequences.

A “frame” refers to a particular image or other discrete unit within a video.

An “object” refers to an item of interest in a video. Examples of an object include: a person, a vehicle, an animal, and a physical subject.

A “target” refers to the computer's model of an object. The target is derived from the image processing, and there is a one-to-one correspondence between targets and objects.

“Pan, tilt and zoom” refers to robotic motions that a sensor unit may perform. Panning is the action of a camera rotating sideward about its central axis. Tilting is the action of a camera rotating upward and downward about its central axis. Zooming is the action of a camera lens increasing the magnification, whether by physically changing the optics of the lens, or by digitally enlarging a portion of the image.

A “best shot” is the optimal frame of a target for recognition purposes, by human or machine. The “best shot” may be different for computer-based recognition systems and the human visual system.

An “activity” refers to one or more actions and/or one or more composites of actions of one or more objects. Examples of an activity include: entering; exiting; stopping; moving; raising; lowering; growing; shrinking, stealing, loitering, and leaving an object.

A “location” refers to a space where an activity may occur. A location can be, for example, scene-based or image-based. Examples of a scene-based location include: a public space; a store; a retail space; an office; a warehouse; a hotel room; a hotel lobby; a lobby of a building; a casino; a bus station; a train station; an airport; a port; a bus; a train; an airplane; and a ship. Examples of an image-based location include: a video image; a line in a video image; an area in a video image; a rectangular section of a video image; and a polygonal section of a video image.

An “event” refers to one or more objects engaged in an activity. The event may be referenced with respect to a location and/or a time.

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.

A “sensing device” refers to any apparatus for obtaining visual information. Examples include: color and monochrome cameras, video cameras, closed-circuit television (CCTV) cameras, charge-coupled device (CCD) sensors, complementary metal oxide semiconductor (CMOS) sensors, analog and digital cameras, PC cameras, web cameras, and infra-red imaging devices. If not more specifically described, a “camera” refers to any sensing device.

A “blob” refers generally to a set of pixels that are grouped together before further processing, and which may correspond to any type of object in an image (usually, in the context of video). Examples of blobs include moving objects (e.g., people and vehicles) and stationary objects (e.g., furniture and consumer goods on shelves in a store).

### BRIEF DESCRIPTION OF THE DRAWINGS

Specific embodiments of the invention will now be described in further detail in conjunction with the attached drawings, in which:

FIG. 1 depicts a conceptual embodiment of the invention, showing a single camera according to the invention conceptually as two cooperating cameras;

FIG. 2 depicts a conceptual block diagram of a single camera according to an embodiment of the invention;

FIG. 3 depicts a conceptual block diagram of a vision module of a camera in a first mode according to the invention;

FIG. 4 depicts a conceptual block diagram of a vision module of a camera in a second mode according to an embodiment of the invention;

FIG. 5 depicts a process flow diagram of the switching behavior of a system according to an embodiment of the invention; and

FIG. 6 depicts a process flow diagram of a portion of a tracking algorithm used in an embodiment of the invention.

### DETAILED DESCRIPTION OF EMBODIMENTS OF THE INVENTION

Overall System

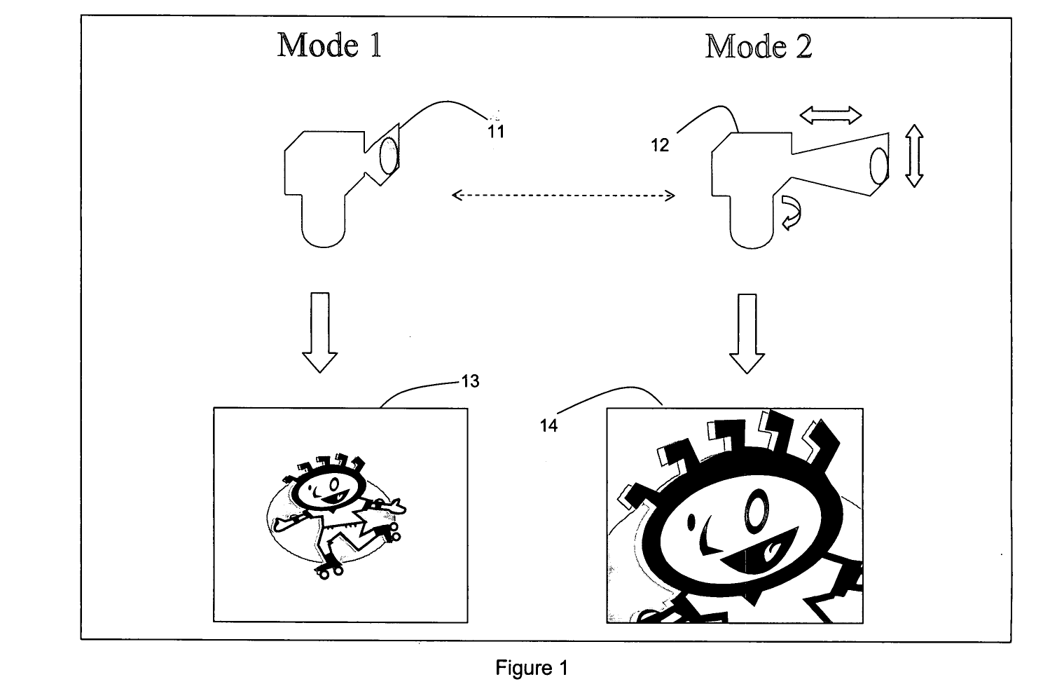

FIG. 1 depicts a conceptual embodiment of the invention using cameras 11 and 12; in the present invention, these cameras 11 and 12 are implemented using a single camera (as indicated by the dashed arrow between cameras 11 and 12). The system of FIG. 1 uses a camera 11 in one mode to provide an overall picture of the scene 13, and camera 12 in a second mode to provide high-resolution pictures of targets of interest 14. In this embodiment, the combination of cameras 11 and 12 will typically comprise a camera with a zoom lens and pan-tilt-zoom (PTZ) means, allowing the camera to be positioned as needed to obtain high-resolution pictures of the target 14 when such target is detected by the camera operating in a wide-angle mode (with or without panning).

The camera of the present invention may, for example, comprise a video camera (or other video sensing device) having a motorized zoom lens and a motorized platform that allows the camera to pan and/or tilt. The video camera and platform will be coupled to a computer running software that performs a number of tasks, which depend on which mode the camera is in. In a first mode, the tasks include segmenting moving objects from the background, combining foreground pixels into blobs, deciding when blobs split and merge to become targets, tracking and classifying targets, and responding to a watchstander (for example, by means of e-mail, alerts, or the like) if the targets engage in predetermined activities (e.g., entry into unauthorized areas). Examples of detectable actions include crossing a tripwire, appearing, disappearing, loitering, and removing or depositing an item.

With the camera initially in the first mode, a scanning (typically, wide-angle) mode of operation, the computer analyzes the video output of the camera, to detect the presence of an interesting target. An interesting target is a target that has performed a predetermined activity; it is not merely any moving object in the field of view. Upon detecting a predetermined activity, the computer will perform the desired response (send an email, log an alert, or the like), and then switch to the second mode.

In the second mode, a pan, tilt, and zoom (PTZ) mode, the computer continues to analyze the video output of the camera, in order to track the target. Using the image position of the target, the computer controls the robotic PTZ sensor to keep the target in the center of view and maintain the maximal zoom on the target. It also monitors for events to indicate that the system should reset to the first mode, including how long the camera has been in this mode, an external trigger (such as a human keyboard request), or if the target has escaped the camera's field-of-view. If any of these events occur, the computer switches the camera back to the first mode.

System-Level Description of Each Mode

The operation of the system in both modes will now be described in further detail.

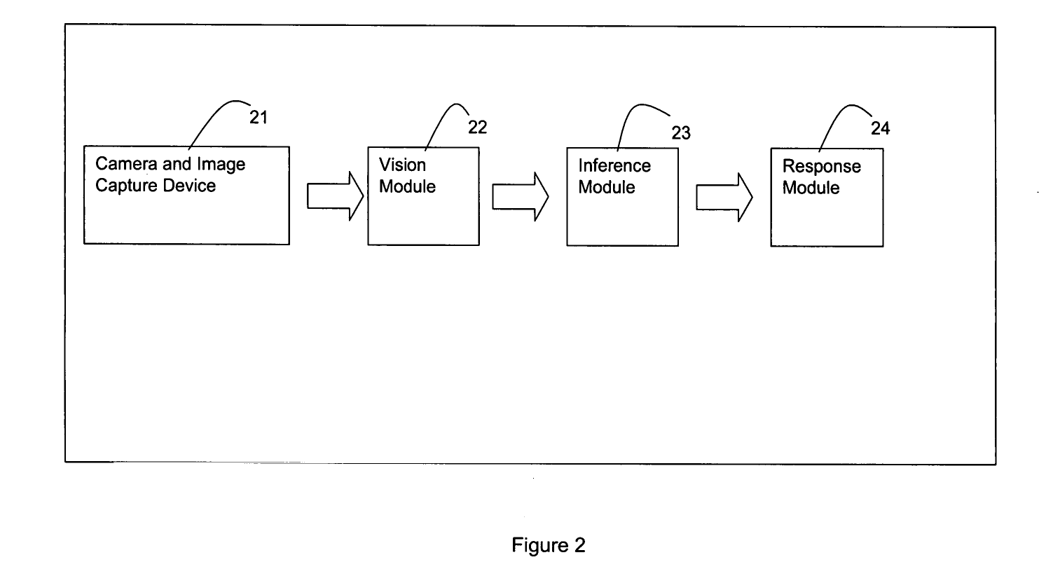

FIG. 2 depicts the different modules comprising a sensing unit according to an embodiment of the present invention. The sensing unit includes a sensor device capable of obtaining an image; this is shown as “Camera and Image Capture Device” 21. Device 21 obtains (video) images and feeds them into memory (not shown). Sensing device 21 may comprise any means by which such images may be obtained. Sensing device 21 has means for attaining higher quality images, and, in this embodiment, is capable of being panned, tilted, and zoomed and may, for example, be mounted on a platform to enable panning and tilting and be equipped with a zoom lens or digital zoom capability to enable zooming.

A vision module 22 processes the stored image data, performing, e.g., fundamental threat analysis and tracking. In particular, vision module 22 uses the image data to detect and classify targets. Optionally equipped with the necessary calibration information, this module has the ability to geo-locate these targets. The operation of vision module 22 varies, depending on whether the system is operating in the first mode or in the second mode.

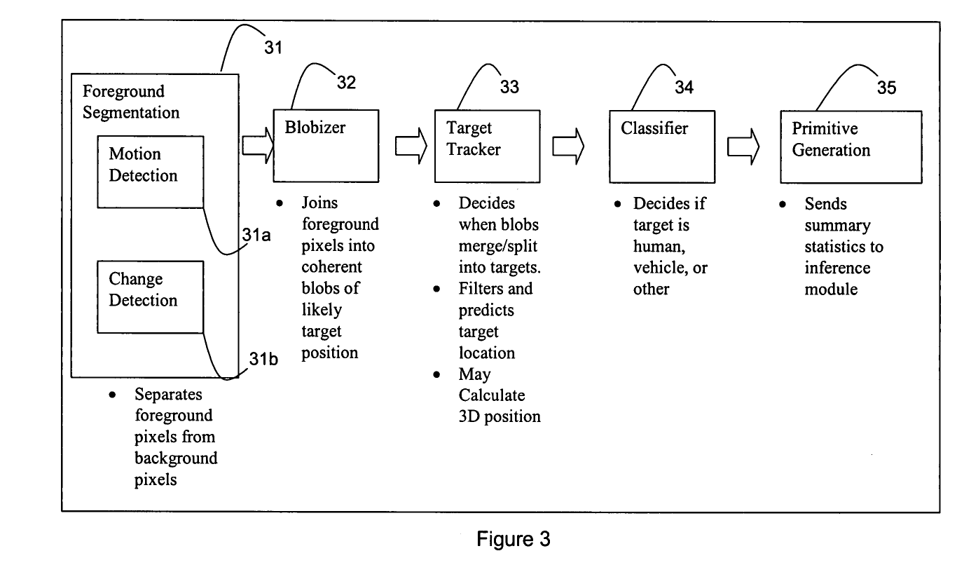

FIG. 3 depicts operation of vision module 22 in the first (scanning) mode. As shown in FIG. 3, vision module 22 includes a foreground segmentation module 31. Foreground segmentation module 31 determines pixels corresponding to background components of an image and foreground components of the image (where “foreground” pixels are, generally speaking, those associated with moving objects). Motion detection, module 31a, and change detection, module 31b, operate in parallel and can be performed in any order or concurrently. Any motion detection algorithm for detecting movement between frames at the pixel level can be used for block 31a. As an example, the three frame differencing technique, discussed in A. Lipton, H. Fujiyoshi, and R. S. Patil, “Moving Target Detection and Classification from Real-Time Video,” Proc. IEEE WACV '98, Princeton, N.J., 1998, pp. 8-14 (subsequently to be referred to as “Lipton, Fujiyoshi, and Patil”), can be used.

In block 31b, foreground pixels are detected via change. Any detection algorithm for detecting changes from a background model can be used for this block. An object is detected in this block if one or more pixels in a frame are deemed to be in the foreground of the frame because the pixels do not conform to a background model of the frame. As an example, a stochastic background modeling technique, such as the dynamically adaptive background subtraction techniques described in Lipton, Fujiyoshi, and Patil and in commonly-assigned, U.S. patent application Ser. No. 09/694,712, filed Oct. 24, 2000, and incorporated herein by reference, may be used.

As an option (not shown), if the video sensor is in motion (e.g. a video camera that pans, tilts, zooms, or translates), an additional block can be inserted in block 31 to provide background segmentation. Change detection can be accomplished by building a background model from the moving image, and motion detection can be accomplished by factoring out the camera motion to get the target motion. In both cases, motion compensation algorithms provide the necessary information to determine the background. A video stabilization that delivers affine or projective motion image alignment, such as the one described in U.S. patent application Ser. No. 09/606,919, filed Jul. 3, 2000, which is incorporated herein by reference, can be used to obtain video stabilization.

Further details of an exemplary process for performing background segmentation may be found, for example, in commonly-assigned U.S. patent application Ser. No. 09/815,385, filed Mar. 23, 2001, and incorporated herein by reference in its entirety.

Change detection module 31 is followed by a “blobizer” 32. Blobizer 32 forms foreground pixels from module 31 into coherent blobs corresponding to possible targets. Any technique for generating blobs can be used for this block. An exemplary technique for generating blobs from motion detection and change detection uses a connected components scheme. For example, the morphology and connected components algorithm described in Lipton, Fujiyoshi, and Patil can be used.

The results from blobizer 32 are fed to target tracker 33. Target tracker 33 determines when blobs merge or split to form possible targets. Target tracker 33 further filters and predicts target location(s). Any technique for tracking blobs can be used for this block. Examples of such techniques include Kalman filtering, the CONDENSATION algorithm, a multi-hypothesis Kalman tracker (e.g., as described in W. E. L. Grimson et al., “Using Adaptive Tracking to Classify and Monitor Activities in a Site, CVPR, 1998, pp. 22-29, and the frame-to-frame tracking technique described in U.S. patent application Ser. No. 09/694,712, referenced above. As an example, if the location is a casino floor, objects that can be tracked may include moving people, dealers, chips, cards, and vending carts.

As an option, blocks 31-33 can be replaced with any detection and tracking scheme, as is known to those of ordinary skill. One example of such a detection and tracking scheme is described in M. Rossi and A. Bozzoli, “Tracking and Counting Moving People,” ICIP, 1994, pp. 212-216.

As an option, block 33 may calculate a 3D position for each target. In order to calculate this position, the camera may have any of several levels of information. At a minimal level, the camera knows three pieces of information—the downward angle (i.e., of the camera with respect to the horizontal axis at the height of the camera), the height of the camera above the floor, and the focal length. At a more advanced level, the camera has a full projection matrix relating the camera location to a general coordinate system. All levels in between suffice to calculate the 3D position. The method to calculate the 3D position, for example, in the case of a human or animal target traces a ray outward from the camera center through the image pixel location of the bottom of the target's feet. Since the camera knows where the floor is, the 3D location is where this ray intersects the 3D floor. Any of many commonly available calibration methods can be used to obtain the necessary information. Note that with the 3D position data, derivative estimates are possible, such as velocity, acceleration, and also, more advanced estimates such as the target's 3D size.

A classifier 34 then determines the type of target being tracked. A target may be, for example, a human, a vehicle, an animal, or another specific type of object. Classification can be performed by a number of techniques, and examples of such techniques include using a neural network classifier and using a linear discriminant classifier, both of which techniques are described, for example, in Collins, Lipton, Kanade, Fujiyoshi, Duggins, Tsin, Tolliver, Enomoto, and Hasegawa, “A System for Video Surveillance and Monitoring: VSAM Final Report,” Technical Report CMU-RI-TR-00-12, Robotics Institute, Carnegie-Mellon University, May 2000.

Finally, a primitive generation module 35 receives the information from the preceding modules and provides summary statistical information. These primitives include all information that the downstream Inference Module 23 might need. For example, the size, position, velocity, color, and texture of the target may be encapsulated in the primitives. Further details of an exemplary process for primitive generation may be found in commonly-assigned U.S. patent application Ser. No. 09/987,707, filed Nov. 15, 2001, and incorporated herein by reference in its entirety.

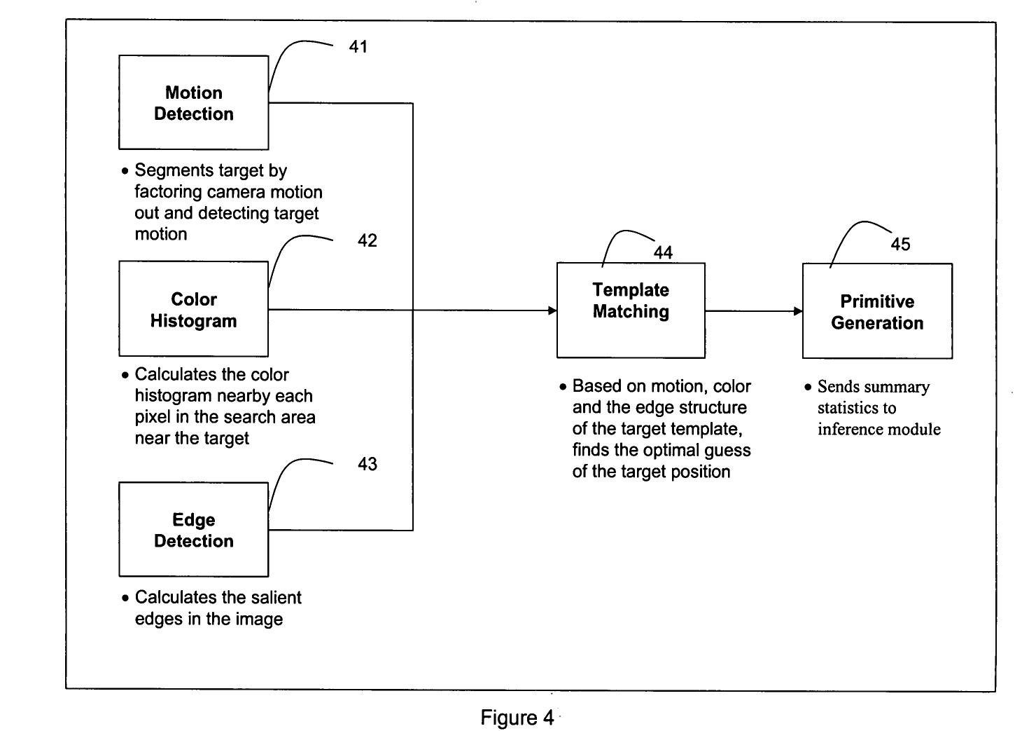

FIG. 4 depicts operation of vision module 22 in the second (PTZ) mode. In the second mode, vision module 22 uses a combination of several visual cues to determine target location, including color, target motion, and edge structure. Note that although the methods used for visual tracking in the vision module of the first mode can be used, it may be advantageous to use a more customized algorithm to increase accuracy, as described below. The algorithm below describes target tracking without explicitly depending on blob formation. Instead, it uses an alternate paradigm involving template matching.

The first cue, target motion, is detected in module 41. The module separates motion of the sensing device 21 from other motion in the image. The assumption is that the target of interest is the primary other motion in the image, aside from camera motion. Any camera motion estimation scheme may be used for this purpose, such as the standard method described, for example, in R. I. Hartley and A. Zisserman, Multiple View Geometry in Computer Vision, Cambridge University Press, 2000. A further embodiment of the invention uses a method discussed below.

The motion detection module 41 and color histogram module 42 operate in parallel and can be performed in any order or concurrently. Color histogram module 42 is used to succinctly describe the colors of areas near each pixel. Any histogram that can be used for matching will suffice, and any color space will suffice. An exemplary technique uses the HSV color space, and builds a one dimensional histogram of all hue values where the saturation is over a certain threshold. Pixel values under that threshold are histogrammed separately. The saturation histogram is appended to the hue histogram. Note that to save computational resources, a particular implementation does not have to build a histogram near every pixel, but may delay this step until later in the tracking process, and only build histograms for those neighborhoods for which it is necessary.

Edge detection module 43 searches for edges in the intensity image. Any technique for detecting edges can be used for this block. As an example, one may use the Laplacian of Gaussian (LoG) Edge Detector described, for example, in D. Marr, Vision, W.H. Freeman and Co., 1982, which balances speed and accuracy (note that, according to Marr, there is also evidence to suggest that the LoG detector is the one used by the human visual cortex).

The template matching module 44 uses the motion data 41, the edge data 42, and the color data 43 from previous modules. Based on this information, it determines a best guess at the position of the target. Any method can be used to combine these three visual cues. For example, one may use a template matching approach, customized for the data. One such algorithm calculates three values for each patch of pixels in the neighborhood of the expected match, where the expected match is the current location adjusted for image motion and may include a velocity estimate. The first value is the edge correlation, where correlation indicates normalized cross-correlation between image patches in a previous image and the current image. The second value is the sum of the motion mask, determined by motion detection 41, and the edge mask, determined by edge detection 43, normalized by the number of edge pixels. The third value is the color histogram match, where the match score is the sum of the minimum between each of the two histograms' bins.

$$Match = {\sum }_{i ∈ Bins}^{} Min ( {Hist1}_{i} , {Hist2}_{i} )$$

To combine these three scores, the method takes a weighted average of the first two, the edge correlation and the edge/motion summation, to form an image match score. If this score corresponds to a location that has a histogram match score above a certain threshold and also has an image match score above all previous scores, the match is accepted as the current maximum. The template search exhaustively searches all pixels in the neighborhood of the expected match. If confidence scores about the motion estimation scheme indicate that the motion estimation has failed, the edge summation score becomes the sole image match score. Likewise, if the images do not have any color information, then the color histogram is ignored.

In an exemplary embodiment, once the target has been found, the current image is stored as the old image, and the system waits for a new image to come in. In this sense, this tracking system has a memory of one image. A system that has a deeper memory and involves older images in the tracking estimate could also be used.

To save time, the process may proceed in two stages using a coarse-to-fine approach. In the first pass, the process searches for a match within a large area in the coarse (half-sized) image. In the second pass, the process refines this match by searching within a small area in the full-sized image. Thus, much computational time has been saved.

The advantages of such an approach are several. First, it is robust to size and angle changes in the target. Whereas typical template approaches are highly sensitive to target rotation and growth, the method's reliance on motion alleviates much of this sensitivity. Second, the motion estimation allows the edge correlation scheme to avoid “sticking” to the background edge structure, a common drawback encountered in edge correlation approaches. Third, the method avoids a major disadvantage of pure motion estimation: schemes in that it does not simply track any motion in the image, but attempts to remain “locked onto” the structure of the initial template, sacrificing this structure only when the structure disappears (in the case of template rotation and scaling). Finally, the color histogram scheme helps eliminate many spurious matches. Color is not a primary matching criterion because target color is usually not distinctive enough to accurately locate the new target location in real-world lighting conditions.

Finally, primitive generation module 45 operates similarly to the corresponding primitive generation module 35 of FIG. 3. That is, based on the information determined by the previous modules, it provides summary statistics.

Vision module 22 is followed by an inference module 23. Inference module 23 receives and further processes the summary statistical information from primitive generation module 35, 45 of vision module 22. In particular, in the first mode, inference module 23 may, among other things, determine when a target has engaged in a prohibited (or otherwise specified) activity (for example, when a person enters a restricted area).

In the second mode, inference module 23 may monitor the length of time that the camera has been in the second mode and may decide whether to switch back to the first mode. It may also detect external stimuli, such as a human keyboard signal or any other signal, which tells the system to switch back to the first mode. In the second mode, the inference engine will also switch the system back to the first mode if the target has been lost, as indicated by a low confidence score in the matching process. In addition, the inference module 23 of the second mode may also include a conflict resolution algorithm, which may include a scheduling algorithm, where, if there are multiple targets in view, the module chooses which target will be tracked. If a scheduling algorithm is present as part of the conflict resolution algorithm, it determines an order in which various targets are tracked (e.g., a first target may be tracked until it is out of range; then, a second target is tracked; etc.).

Finally, a response module 24 implements the appropriate course of action in response to detection of a target engaging in a prohibited or otherwise specified activity. In the first mode, such course of action may include sending e-mail or other electronic-messaging alerts, audio and/or visual alarms or alerts, and sending position data (physical device commands) to sensing device 21 for tracking the target. In the first mode, the response module is also responsible for switching from the first mode to the second mode. The complication that often arises in this case is how to initialize the tracking in the second mode. All information about the target is in the system, and can easily be forwarded to the machinery involved in the second mode. Any method can be used to initialize the tracker in the second mode. An exemplary method uses a bounding box from the first mode to select a template in the second mode.

In the second mode, the response module 24 translates the image position of the target into a useful pan-tilt-zoom command for the motorized platform (PTZ) to follow. In the case where the second mode consists of obtaining high quality imagery in another way, the response module would initiate this as well (super-resolution processing, other filters, etc).

In one embodiment of the invention, the method that the response module uses to decide the PTZ command in the second mode consists of first noting the target location in the image as a percentage of the image dimension (e.g., on a scale from zero to one, each of horizontally and vertically). The module then subtracts 0.5 from these two values and multiplies each difference by a gain constant to get the appropriate pan and tilt value. The zoom value is decided by noting the size of the target in the image. A size threshold decides whether to zoom further inward or outward. To avoid image jitter, the zooming may be smoothed using a running median filter. A more complicated control system may be used for all of pan, tilt and zoom values, involving filtering and prediction. An exemplary choice would involve using a Kalman filter. The signal from the response module can be sent in any way from the computer system to the PTZ unit, including a cable and wireless methods, using any protocol.

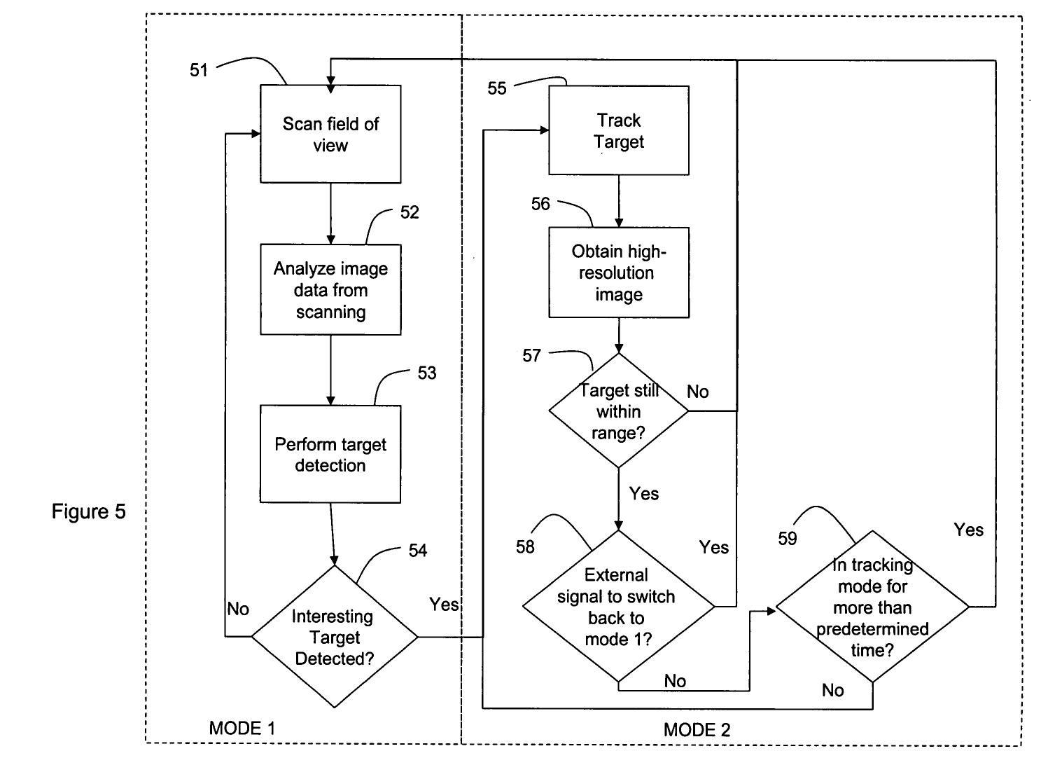

Overall operation of the system is now described in connection with FIG. 5. In the first mode, the system scans the field of view of sensing device 21 in Step 51. As discussed above, the field of view of sensing device 21 may be fixed or may pan a particular area. The image data generated by sensing device 21 in Step 51 is analyzed by the system in Step 52. The system detects whether there is a target present (Step 53) and decides whether to change modes (Step 54). If a target is not present, the process remains in the first mode and returns to Step 51. If a target is present, the system enters the second mode, and the process goes to Step 55.

In Step 55, the system tracks the target using sensing device motion data and image data, as described above. The tracking permits the sensing device 21 to home in on the target and to obtain high-resolution image data (Step 56). The system, in Step 57, continuously monitors whether or not the target is still within range of the sensing device, returning to the first mode (Step 51) if not. If it is, then, as long as the system has not been in the second (tracking) mode for more than a predetermined period of time or received an external stimulus (Step 58), the system continues to track the target, returning to Step 55. Otherwise, the process returnsto Step 51 (the first mode).

Motion Segmentation Algorithm

In general, motion segmentation algorithms, as used in module 31a, are one method used for tracking objects in video sequences. The problem, in general, is to find the parameters of camera motion between one image and the next image in a sequence. Given this transformation, one can transform, or warp, one image to the location of the other and take the difference between the two images. If the pixel-wise absolute difference is above a certain threshold, then those pixels are deemed to have moved. Of course, the algorithm assumes that the objects in motion are of a different intensity or color than the background, and also that the objects in motion are moving at a different velocity than the camera. If either of these two preconditions are violated, all current motion segmentation methods will fail.

In the universal, projective case, the camera motion can be in any direction, and the transformation from one image to the next is a projective transformation involving nine parameters. If the camera motion were known beforehand and the camera parameters were known through calibration, one could predetermine this transformation. However, there are a few reasons why even with calibration information, image-based methods are useful. First, the vision algorithms would need to communicate perfectly with the robotic platform and determine when each operation was complete. Imperfect communications, in the form of lack of interrupt signals in many hardware pieces and mis-synchronized processes, and having to wait for each PTZ motion to complete prohibit this option. Additionally, pan-tilt-zoom cameras are hard to calibrate, especially since the common assumption that the camera center is the center of rotation is often suspect when the target is close to the camera.

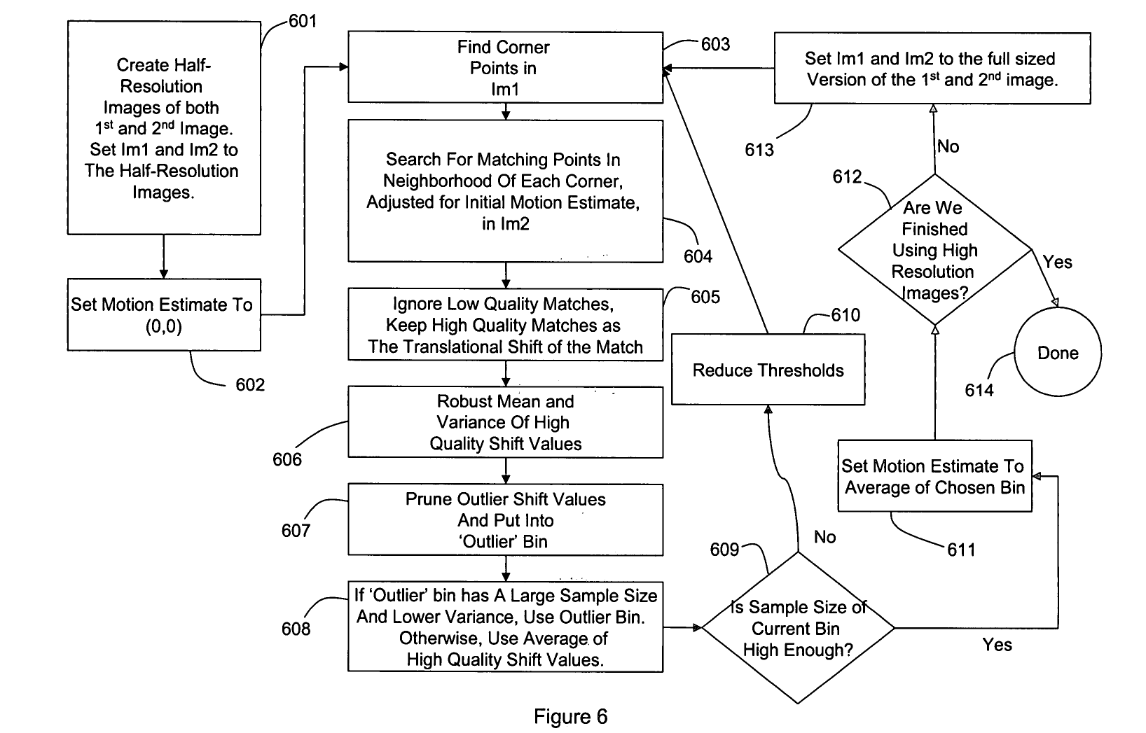

The motion algorithm according to a preferred embodiment of the invention proceeds in two phases—in a first phase, image alignment finds the transformation between two images, and in a second phase, subtraction finds the moving pixels. FIG. 6 illustrates a flow diagram for the image alignment portion of the motion segmentation algorithm. The algorithm proceeds in two stages, coarse and then fine. The two stages are substantially the same, but the coarse stage uses half-sized images 601, while the fine stage uses full-sized images (not specifically shown). The coarse-fine approach reduces the computational resources required and, for a given computational budget, increases accuracy. The first phase searches for large motion in the image, while the second phase searches for smaller motion. Because the coarse image size is half in each dimension, there are a quarter the number of pixels, and computation is dramatically reduced.

In the coarse phase, after creating half-resolution images 601, the process continues a process of initialization by setting a motion estimate to (0,0) 602.

The image alignment for each resolution level, coarse or fine, next finds “interesting points” to anchor the search process 603. Any method of finding interesting points will work. An exemplary embodiment uses the Harris corner detector method, which is known in the art. Note that the current location of a target is prevented from having interesting points because it is assumed that the target moves differently from the camera.

For each of these corner points (i.e., in the case in which the interesting points are corner points), the algorithm searches for a matching point in the second image 604. Any method of point matching will work. An exemplary embodiment uses normalized cross-correlation to match the intensity of small patches around each interesting pixel by searching within a predefined range for a match.

The algorithm then deems whether the match is of high enough quality to include it as an estimate of camera motion 605. There are many confidence metrics that will determine the quality of the match, and any method will work. An exemplary method uses the matching score, the curvature around the match, the variance in the underlying patches at the maximal score, and the underlying interest score as indicators of match quality. The matches are stored in terms of their translational shifts.

After assembling a list of predetermined size of these high quality shifts, the method trims outliers. Any method to trim outliers will work. An exemplary method, shown in FIG. 6, takes the average and the standard deviation 606, and all points outside a certain multiple of the standard deviation of the mean are considered outliers. After trimming, two lists are kept—one of the low variance shifts, and a second of all outliers (in an “outlier bin”) 607. If the outliers have lower variance than the low variance shifts and there are sufficiently many of them, then the outliers are deemed the winners 608. If the sample size of the winning bin is deemed high enough 609, then the final motion estimate is taken as the average of all shifts in the low variance, or winning, bin 611.

If the sample size of the winning bin is not deemed high enough 609, then at least one threshold is changed 610, where “threshold” refers to a criterion used to determine whether a match is of low or high quality or if a shift value is or is not an outlier. In this case, the process is repeated, beginning at block 603.

When the process reaches block 611, the process then determines whether or not it is finished 612. The process is finished 614 when both the coarse (low resolution) and fine (high resolution) images have been examined. Otherwise, after only the coarse images have been examined, the system re-initializes using the fine images 613 and repeats a slightly modified version of the process, beginning at block 603.

To explain further, the second (fine) phase of the process uses the results of the first (coarse) phase to reduce the computational requirements of the second phase. In particular, the results of the first phase are stored for the second phase and are used to limit the image areas to be searched in the second phase. That is, only the areas around the areas pinpointed in the first phase are examined in the second phase.

The preferred image alignment scheme may be embedded in a three frame differencing approach. The entire method described above is performed twice—once from image 2 to image 1 and once from image 2 to image 3. The idea behind the three frame approach is that a moving object creates two areas of difference between two images: one in the place the object has vacated, and another in the place to which the object has moved. The intersection of the motion among three images will contain only the motion associated with getting the object to the place in the image to which it has moved. Thus, three frame differencing reduces false positives and overall noise in the motion segmentation. The only cost is a frame of latency in the overall vision module pipeline.

Best Shot Selection

In an enhanced embodiment, the system may be used to obtain a “best shot” of the target. A best shot is the optimal, or highest quality, frame in a video sequence of a target for recognition purposes, by human or machine. The best shot may be the “best” for various targets, including human faces and vehicles. The idea is not necessarily to recognize the target, but to at least calculate those features that would make recognition easier. Any technique to predict those features can be used.

There are multiple ways to include best shot functionality into the system and method described above. As a first example, the best shot would reside in vision module 22 in the first mode. For any target that passes through the field of view, the vision module would indicate that a particular frame is the “best shot”, and the primitive generator 35 would send this information to the inference module 23. The inference module 23 would decide whether the target is interesting, and if it is, trigger the response module 24. An interesting target may be one that has violated another predetermined rule, such as a target that has entered restricted space, loitered, dropped a bag or the like. The net result is that the response module 24 could deliver a best shot to an alert for a human to recognize or also a best shot to another software module (in an external system) that will perform face recognition, or any other automated recognition system.

A exemplary method to include best shot functionality would reside in vision module 22 of the second mode. The module-level description is the same as above, but the functionality would allow for a moving camera and whatever other methods are used to obtain the higher quality imagery in the second mode. The purpose of the second mode is to obtain high quality imagery, so the best shot functionality is a natural fit into the purpose of the second mode.

The best shot module would optionally fit between modules 33 and 34, or 43 and 44. The technology combines several image quality measures. A first metric group assumes larger image sizes of particular targets are the best predictor of recognition. The first measure is the size of the blob of a particular color. In the case of human recognition, the system would recognize skin-toned pixels. Any techniques to recognize skin-toned pixels would work. An exemplary technique is described in M. J. Jones and J. M. Rehg, “Statistical Color Models with Application to Skin Detection,” Cambridge Research Laboratory Technical Report CRL 98/11, 1998. In the case of vehicle recognition, the blob color would be that of the vehicle's particular color.

The second metric used is the target trajectory. In the case of human recognition, a frontal view would be optimal, and a trajectory of a human heading towards the camera would likely indicate a frontal view. In the case of vehicle recognition, a rearward view might be optimal for identifying information (license plate, make/model), and the trajectory could likewise indicate that. Without calibration information, image trajectory can be incorporated into the first mode, in which it is calculated by motion towards the top or bottom of the image. The change in blob size is another indicating factor of trajectory in the first mode. In the second mode, if the camera is moving, in the above methods, PTZ trajectory can substitute for target trajectory, where upwards indicates that the target is moving farther away and vice versa.

A second group of metrics tests for image focus and image noise. Any technique that measures these quantities will work. One method to measure image focus monitors the high frequency content of the blob using the fast Fourier transform (FFT) in the same way that autofocus methods search for optimal focus. The image noise can be measured offline by comparing the image variation of static objects over time and under various lighting conditions. Other measures of image quality can easily be included by one of ordinary skill in the art.

A weighted average of any included,measures constitutes the overall shot quality metric. The weights can be based on prior experimental data or on confidence metrics calculated during operation. The result is a quality metric, and the problem then turns to optimizing this metric. In this case, optimization is simple because the method generates a list of all frames with all targets and their associated shot quality metrics. A list traversal will reveal the maximum. The full list is available when the target is lost. However, a best shot may be requested at any time for all data available up to that point.

Multi-Camera Handoff

In a further embodiment of the invention, multiple systems may be interfaced with each other to provide broader spatial coverage and/or cooperative tracking of targets. In this embodiment, each system is considered to be a peer of each other system. Such a system may operate, for example, as follows.

Considering an overall system consisting of two active-camera systems (to be referred to as “A” and “B”), initially, both would be in the first mode, scanning for targets. Upon detection of a target, the system that detects the target (say, A) would then first attempt to enter the second mode. If A is successful in tracking the target in the second mode, then A would do so and would notify B of the position of the target so that B does not enter the second mode if it detects the same target. If A reaches a point where it is unable to further track the target, it would then notify B of the target's last known position. B would then, still in the first mode, immediately scan an area in the vicinity of the last known position of the target. If the target is detected, B would then enter the second mode and continue tracking of the target. Otherwise, B would return to scanning its entire area of coverage for possible targets. Through this arrangement, systems A and B are capable of handing off targets to each other to provide near-continuous tracking of the targets. Note that best shot capability may be incorporated into this embodiment, as well.

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A video surveillance system comprising:
a sensing unit capable of being operated in a first mode and second mode; and
a computer system coupled to the sensing unit, the computer system receiving and processing image data from the sensing unit, detecting and tracking targets, and determining whether the sensing unit operates in the first mode or in the second mode based on the detection and tracking of targets.

2. The video surveillance system of claim 1, wherein the sensing unit comprises means for improving quality of information obtained about a target.

3. The video surveillance system of claim 2, wherein the means for improving quality of information obtained performs at least one of: panning, tilting, and zooming; using a super-resolution algorithm; instructing the sensing unit to digitally zoom; employing different lenses or filters to view the target; and using a robotic actuator.

4. The video surveillance system of claim 3, wherein the computer system includes a response module adapted to, in the second mode, obtain improved quality information about the target.

5. The video surveillance system of claim 2, wherein the computer system provides signals to control the means for improving quality of information obtained about a target.

6. The video surveillance system of claim 1, wherein the sensing unit comprises at least one of a camera, an infra-red sensor, a thermal sensor, a radio sensor, and an algorithmically enhanced camera group.

7. The video surveillance system of claim 1, wherein the computer system comprises:
a vision module to process output of the sensing unit;
an inference module to process output of the vision module; and
a response module to perform one or more actions based on the output of the inference module.

8. The video surveillance system of claim 7, wherein, in the first mode, the vision module detects at least one of blobs and targets.

9. The video surveillance system of claim 7, wherein, in the first mode, the vision module comprises:
a segmentation module to separate background pixels from foreground pixels;
a blobizer to receive the foreground pixels from the segmentation module and to group connected foreground pixels into coherent blobs;
a target tracker to process the coherent blobs, determine when they are targets, and to obtain position information for each target;
a classifier to determine a target type for each target; and
a primitive generation module to generate summary statistics to be sent to the inference module.

10. The video surveillance system of claim 7, wherein, in the first mode, the inference module determines when at least one specified condition has been either met or violated.

11. The video surveillance system of claim 7, wherein the response module is adapted to perform at least one of the following: sending an e-mail alert; sounding an audio alarm; providing a visual alarm; logging an alert to a persistent medium; making a telephone call; transmitting a wireless message to a personal digital assistant; enabling a mechanical actuator; and providing position information to another sensing unit.

12. The video surveillance system of claim 7, wherein, in the second mode, the vision module employs at least one of target motion, color and edge information derived from the image data to determine target location.

13. The video surveillance system of claim 7, wherein, in the second mode, the vision module comprises:
a motion detection module that determines camera motion and segments target motion after having factored out camera motion;
a color histogram module that calculates a color histogram for a region near each pixel in an area near a target;
an edge detection module that determines edges in any given image;
a template matching module that uses motion segmentation and color information, as well as an edge structure of a target template, to determine a best guess of the target's position; and
a primitive generation module that generates summary statistical information based on the best guess of the target's position.

14. The video surveillance system of claim 13, wherein the motion detection module comprises: a corner detection module to find interesting points;
a search module to find matches for interesting points between successive images;
a confidence value assignment module to assign confidence values to the matches of the interesting points;
a robust averaging module to determine an estimate from a set of high confidence matches;
a warping module to warp one successive image to another successive image for direct comparison of the images; and
a subtraction module, which subtracts the warped image from a current image to determine which pixels have moved.

15. The video surveillance system of claim 7, wherein, in the second mode, the inference module determines whether to switch back to the first mode by monitoring at least one of how long the system has been in the second mode, the position of the target in the image, the position of the target in a world coordinate frame, and one or more external stimuli.

16. The video surveillance system of claim 7, wherein, in the second mode, the response module receives higher quality information about the target than in the first mode.

17. The video surveillance system according to claim 1, further comprising:
a second sensing unit capable of being operated in the first mode and second mode; and
a second computer system coupled to the second sensing unit and to the computer system, the second computer system receiving and processing image data from the second sensing unit, detecting and tracking targets, and determining whether the second sensing unit operates in the first mode or in the second mode based on the detection and tracking of targets,
wherein the computer system and the second computer system cooperate to coordinate handoff between the sensing unit and the second sensing unit to track at least one target.

18. A method of operating a video surveillance system, the video surveillance system including at least one sensing unit capable of being operated in first and second modes, the method comprising the steps of:
operating a sensing unit in the first mode to scan for targets;
processing image data from the sensing unit in a first mode to detect the presence of an interesting target;
upon detecting an interesting target, operating the sensing unit in the second mode to track the interesting target and to improve the quality of information about the interesting target over the information that can be obtained in the first mode; and
processing image data from the sensing unit in a second mode to track the target by sending at least one of pan, tilt, and zoom commands to the sensing unit.

19. The method of claim 18, wherein the step of operating the sensing unit in the first mode comprises the step of performing at least one of:
operating the sensing unit in a wide-angle mode to scan for targets.

20. The method of claim 18, wherein the step of operating the sensing unit in the second mode comprises the steps of:
obtaining higher quality imagery of a target than that obtained by operating the sensing unit in the first mode through the use of at least one of the following:
panning, tilting, and zooming;
using super-resolution algorithms;
digitally zooming into the image;
employing different lenses or filters; and
using a robotic actuator.

21. The method of claim 18, wherein the step of processing image data from the sensing unit in a first mode comprises the steps of:
processing the image data with a vision module to detect and locate at least one target; and
determining if at least one predetermined condition has been violated by at least one target.

22. The method of claim 21, wherein the step of processing the image data with a vision module comprises the step of:
geo-locating the at least one object in 3D space.

23. The method of claim 21, wherein the step of processing the image data with a vision module comprises the steps of:
classifying pixels in the image information as background pixels or foreground pixels; and
using the foreground pixels to determine at least one blob.

24. The method of claim 23, further comprising the step of tracking at least one possible target based on at least one blob.

25. The method of claim 24, wherein the step of tracking comprises the steps of:
determining when at least one blob merges or splits into one or more possible targets; and
performing at least one of:
filtering and predicting the image location of at least one of the possible targets; and
calculating a 3D position of at least one of the possible targets if calibration information is available.

26. The method of claim 24, further comprising the step of classifying at least one possible target by target type into categories.

27. The method of claim 24, further comprising the step of providing summary statistics to aid in the step of determining if at least one predetermined condition has been violated by at least one object.

28. The method of claim 27, wherein the summary statistics include at least one of the following: an estimate of the target's position in image space; the target's position in a world coordinate frame; the target's size in image space; the target's size in the world coordinate frame; the target's velocity in image space; the target's velocity in the world coordinate frame; the target's trajectory; the target's color; the color of at least one subcomponent of the target; a bounding box for the target in an image; and at least one estimate of location and size of at least one body part, in the case where the target is human.

29. The method of claim 18, wherein the step of processing image data from the sensing unit in a second mode, if the second mode involves camera motion, comprises the steps of:
segmenting the target from the background by detecting motion of the sensing unit and factoring it out;
calculating color histogram information in a region of at least some pixels of image data from the sensing unit;
calculating an edge image; and
using template matching, to integrate the results of the steps of motion segmentation, edge detection and color histogram formation, to obtain an estimate of the target's position.

30. The method of claim 29, wherein the step of processing image data from the sensing unit in a second mode further comprises the step of:
generating summary statistics based on various features of the target.

31. The method of claim 30, wherein the summary statistics include at least one of the following: an estimate of the target's position in image space; the target's position in a world coordinate frame; the target's size in image space; the target's size in the world coordinate frame; the target's velocity in image space; the target's velocity in the world coordinate frame; the target's trajectory; the target's color; the color of at least one subcomponent of the target; a bounding box for the target in an image; and at least one estimate of location and size of at least one body part, in the case where the target is human.

32. The method of claim 29, wherein the step of processing image data from the sensing unit in a second mode further comprises the steps of:
monitoring a length of time in which the system has been in the second mode;
monitoring the various summary statistics to detect if any target characteristic has met a predetermined rule for switching to the first mode;
monitoring for any external stimuli indicating that the system should switch to the first mode; and
if any predetermined conditions are met in any of the monitoring processes, switching back to the first mode.

33. The method of claim 18, further comprising the steps of:
determining a best shot of the target while operating the visual module in either of the first and second modes; and
delivering the best shot back to the user through the response module.

34. The method of claim 18, further comprising the steps of:
if the target exits the field of view of the sensing unit, directing a second sensing unit to scan for and track the target.

35. The method of claim 34, wherein the step of directing a second sensing unit to scan for and track the target comprises the steps of:
receiving, by the second sensing unit, information about a last known position of the target from the sensing unit;
operating the second sensing unit in the first mode to scan for the target, focusing on a region near the last known position;
processing image data from the second sensing unit in the first mode to detect the presence of a target;
upon detecting a target, operating the second sensing unit in the second mode to track the target; and
processing image data from the second sensing unit in the second mode to track the target by sending at least one of pan, tilt, and zoom commands to the second sensing unit,
wherein, if the target is not detected within a predetermined time period in the step of operating the second sensing unit in the first mode to scan for the target, focusing on a region near the last known position, the second sensing unit switches to scanning for targets in its entire field of coverage.

36. A computer-readable medium containing software implementing the method of claim 18.

37. A video surveillance system, comprising:
at least one sensing unit;
at least one computer system; and
the computer-readable medium of claim 36.

38. The method of claim 18, wherein, if operating the sensing unit in the second mode involves camera motion, processing image data from the sensing unit in a second mode comprises:
(a) performing corner detection to find interesting points;
(b) searching for matches for interesting points in successive images;
(c) assigning confidence values to the matches of the interesting points;
(d) employing a robust averaging method to determine an estimate from a subset of the matches determined to have high confidence values;
(e) warping a second successive image towards a first successive image; and
(f) subtracting the warped image from a current image to determine which pixels have moved.

39. The method of claim 38, wherein processing image data from the sensing unit in a second mode further comprises:
performing steps (a)-(f) on reduced resolution images; and
performing steps (a)-(f) on full resolution images, utilizing the results of performing steps (a)-(f) on reduced resolution images to reduce the computational burden by limiting the searching to only a subset of the full resolution images.

40. The method of claim 38, wherein processing image data from the sensing unit in a second mode further comprises:
using three-frame differencing to alleviate false motion.

41. A motion detection module to determine camera motion, comprising:
a corner detection module to find interesting points;
a search module to find matches for interesting points between successive images;
a confidence value assignment module to assign confidence values to the matches of the interesting points;
a robust averaging module to determine an estimate from a set of high confidence matches;
a warping module to warp one successive image to another successive image for direct comparison of the images; and
a subtraction module, which subtracts the warped image from a current image to determine which pixels have moved.

42. The motion detection module of claim 41, wherein each module operates first on reduced resolution image data and then on full resolution image data, using the results of operating on reduced resolution image data to reduce a computational burden.

43. The motion detection module of claim 41, wherein the subtraction module uses three-frame differencing to alleviate false motions.

44. A video-based security system, comprising the video surveillance system according to claim 1.

45. A video-based security system, comprising the video surveillance system according to claim 37.

46. A method of operating a video-based security system, comprising the method according to claim 18.

47. An experiment monitoring system, comprising the video surveillance system according to claim 1.

48. An experiment monitoring system, comprising the video surveillance system according to claim 37.

49. A method of monitoring an experiment, comprising the method according to claim 18.

50. The method according to claim 49, further comprising:
focusing in on at least one predetermined behavior of at least one subject of the experiment.

51. A sporting event monitoring system, comprising the video surveillance system according to claim 1.

52. A sporting event monitoring system, comprising the video surveillance system according to claim 37.

53. A method of monitoring a sporting event, comprising the method according to claim 18.

54. The method according to claim 53, further comprising:
detecting at least one predetermined behavior of a participant in the sporting event.

55. A marketing information gathering system, comprising the video surveillance system according to claim 1.

56. A marketing information gathering system, comprising the video surveillance system according to claim 37.

57. A method of gathering marketing information, comprising the method according to claim 18.

58. The method according to claim 57, further comprising:
monitoring at least one behavior of at least one subject.

59. The method according to claim 58, wherein said monitoring comprises:
detecting interest in a given product.

60. The method according to claim 59, wherein said detecting comprises:
detecting when a customer reaches for said given product.

61. An apparatus for video surveillance comprising:
an apparatus adapted to be coupled to a sensing unit capable of being operated in a first mode and second mode, the apparatus adapted to receive and process image data from the sensing unit, detect and track targets, and determine whether the sensing unit operates in the first mode or in the second mode based on the detection and tracking of targets.

62. The apparatus of claim 61, wherein the apparatus comprises application specific hardware to emulate a computer and/or software, wherein said hardware is adapted to perform said video surveillance.
